(19) United States
(12) Patent Application Publication
(10) Pub. No.: US 2006/0241011 A1
(43) Pub. Date: Oct. 26, 2006

(54) Detergent composition and method of using same

(76) Inventor: Lance Renfrow, Tempe, AZ (US)

Correspondence Address: DRUMMOND & DUCKWORTH, Suite 500, 4590 MacArthur Blvd., Newport Beach, CA, 92660, US

(21) Appl. No.: 11/454,383

(22) Filed: Jun. 16, 2006

Related U.S. Application Data
(63) Continuation-in-part of application No. 11/070,997, filed on Mar. 3, 2005.
(60) Provisional application No. 60/692,079, filed on Jun. 20, 2005.

(51) Int. Cl. C11D 3/37

(52) U.S. Cl. 510/499

(57) ABSTRACT

A detergent blend stable in strong oxidizing solutions such as sodium hypochlorite or hydrogen peroxide is prepared by admixing together a fluorinated surfactant and an amine oxide or anionic surfactant. This blend can then be formulated into a detergent concentrate which includes a caustic stabilizing compound and possibly other adjuvants to enable the concentrate to be used as is or diluted into a use solution for use. The use solution prepared from the detergent blend is particularly useful in food and beverage production equipment, delivery lines and general hard surfaces such as consumer bathroom, kitchen, floor and general hard surfaces and other applications where strong oxidizing solutions are used for cleaning.

### CROSS REFERENCE TO RELATED APPLICATIONS

This application is a continuation-in-part application of co-pending U.S. Provisional Patent Application Ser. No. 60/692,079 filed on Jun. 20, 2005 and a continuation-in-part application of co-pending U.S. patent application Ser. No. 11/070,997, filed Mar. 3, 2005, the entire disclosures of which are hereby incorporated by reference.

### BACKGROUND OF THE INVENTION

1. Field of the Invention

The present invention concerns detergent compositions and methods of use therefor. More particularly, the present invention concerns detergent concentrates and use solutions prepared therefrom. Even more particularly, the present invention concerns detergent concentrates and use solutions prepared therefrom and methods of use therefor.

2. Prior Art

In U.S. Patent Application Publication No. 20020037821, published Mar. 28, 2002 for “Detergent Compositions and Methods”; U.S. patent application Ser. No. 10,393,741, filed Mar. 21, 2003; the disclosures of which are hereby incorporated by reference in their entirety, there is disclosed, respectively, (a) a detergent composition which comprises a mixture or blend of a high cloud point and low cloud point surfactant and (b) a caustic stable as well as an acid stable fluorosurfactant-hydrotrope composition. These blends have particular utility in cleaning brewery and food processing apparatus as well as other applications requiring highly concentrated alkaline or acid-based cleaners. According to the inventions defined therewithin, the use solution mixtures or blends have a very low surface tension, are low foaming, and are compatible in both caustic and acid environments.

In the presently co-pending application there is disclosed an improved formulation over that of the above-referred to prior art in that a single surfactant is ultimately hydrotroped into the use solution and, as a consequence thereof, affords a use solution with a much lower surface tension, lower foam and enhanced rinseability estimated to be at least five-fold over the prior art. Necessarily, then, less material is used, providing a major cost savings, with a concomitant reduction in cleaning time to provide a more efficient process and a much cleaner system. However, none of the above formulations are chlorine stable, i.e. none of these formulations are compatible with a chlorine-based or hydrogen peroxide product, i.e. hypochlorite, hydrogen peroxide. The present invention as detailed herein below, accommodates this.

### SUMMARY OF THE INVENTION

In accordance herewith, there is provided a detergent blend stable in strong oxiding solution such as sodium hypochlorite, or chlorine, and hydrogen peroxide which, generally, comprises:

(a) an anionic or amine oxide surfactant, and

(b) a fluorinated surfactant.

This detergent blend is employed in a detergent concentrate from which is prepared a use solution compatible in both a highly concentrated sodium hypochlorite or hydrogen peroxide solution or an acid environment and which is particularly useful for cleaning and sanitizing food or beverage production equipment and hard surfaces including, for example, production equipment, beverage delivery lines, as well as in dairy and other related food processing apparatus. The present composition can also be used in other cleaning applications where sodium hypochlorite or hydrogen peroxide solutions are preferred such as consumer hard surface cleaners, for example, bathroom cleaners, kitchen cleaners, general hard surface cleaners and other related cleaners.

The surfactant blend is stable in strong oxidizing agents including chlorine or sodium hypochlorite (NaOCl) and hydrogen peroxide (H₂0₂). Further, the surfactant blend of the present invention also reduces the surface tension of bleach-containing solutions below 20 dynes/cm whereas conventional chlorine-stable surfactants are only able to reduce the surface tension of such solutions to around 30 dynes/cm. In addition this invention exhibits lower dynamic surface tension properties as well.

For a more complete understanding of the present invention reference is made to the following detailed description and accompanying examples.

### BRIEF DESCRIPTION OF THE DRAWINGS

FIG. 1 is a graph depicting the dynamic surface tension of two preferred detergent blends of the preferred invention as measured by bubble tension tensionmetry; and

FIG. 2 is a graph illustrating the equilibrium surface tension by the Wilhelmy plate method of two preferred detergent blends of the preferred invention.

### DESCRIPTION OF THE PREFERRED EMBODIMENT

As herein above note and in accordance herewith, there is provided a detergent blend stable in strong oxidizing solutions such as sodium hypochlorite or hydrogen peroxide which, generally, comprises:

(a) anionic or amine oxide surfactant, and

(b) a fluorinated surfactant.

This detergent blend is employed in a detergent concentrate from which, in turn, is prepared a chlorine stable use solution compatible in either a caustic or highly alkaline environment and which is useful for cleaning food and beverage production equipment as well as general hard surface cleaners such as consumer bathroom and kitchen cleaners.

The first component of the blend is an amine oxide or anionic surfactant. Amine oxide can be represented by the following structure: 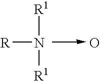
wherein R is lower alkyl having from above 2 to about 18 carbon atoms in the alkyl portion, each R¹ is, independently, where R is a alkyl group having from 6-18 carbon atoms, and each R¹ is, independently, methyl, ethyl, or 2-hydroxethyl. Preferably, R is from 6 to about 12 carbon atoms, i.e. caprylic, coconut, lauryl, or mysistyl. Most preferably R is C₈. Each R is independently, preferably, methyl or 2-hydroxythyl. Thus, representative compounds include, for example, octyl amine oxide, ethyl amine oxide, propylamine oxide, butyl amine oxide and the like, as well as mixture thereof. More specifically, the amine oxides suitable for use herein include, but are not limited to, C₆-C₁₈ alkyl dimethylamine oxides, C₆-C₁₈ acylamido alykyl dimethylamine oxides, acylamido alkyl dimethylamine oxide, trialkyl amine oxides and triakyl phosphine oxides wherein one alkyl group ranges from 6 to 18 carbon atoms and two alkyl groups range from 1 to 3 carbon atoms wherein the alkyl groups can contain hydroxyl substituents including dodecyl di(2-hydroxyethyl) amine oxide and tetradecyl dimethyl phosphine oxide, and so forth. Still additional amine oxide structures are described in U.S. Pat. No. 5,919,980 which is incorporated herein in its entirety by reference.

As an alternative to amine oxide surfactants, anionic surfactants may be employed. Anionic surfactants can contain sulfates, sulfonates, ethoxysulfates, ethoxysulfonates, dodecylbenzene sulfonate, and phosphate esters. Still additional acceptable anionic structures are described in U.S. Pat. No. 5,843,317 which is incorporated herein in its entirety by reference.

The amine oxides and anionic surfactants are stable in caustic solutions primarily because of the lack of either linkages commonly resulting from ethoxylation or propoxylation of surfactants. Similarly, they are compatible in acid media because of the lack of hydrolyzable ester and amine linkages.

In preparing the detergent blend the amine oxide or anionic surfactant is present in an amount, generally, ranging from about 95 to about 99.95%, by weight, based on the total weight of the blend.

In the practice of the present invention a particularly preferred compound is octyldimethylamine oxide. Octyldimethyl amine oxides are well-known and commercially available, such as that sold by McIntyre Group, Ltd. under the name Mackamine C-8.

The surfactant used in the blend, is a fluorinated surfactant or a mixture of such surfactants. Such fluorinated surfactants are anionic, nonionic or cationic having one or more fluorine atoms incorporated thereinto either into the backbone of the surfactant or as a branched substituent.

Among the useful fluorinated surfactants are those which correspond to the formulae:
(CF₂CF₂)ₙ(RO)X
or
CF₃—CF₂(CF₂CF₂)ₙ(CH₂)_{y}X
wherein n is an integer ranging from 1 to about 9, y is an integer ranging from about 0 to about 15 and X is either hydrogen or an anionic radical, which may be selected from the group consisting of sulfate, sulfonate, phosphate, phosphonate, ammonium, thiosulfate, thiosulfonate, and the like, as well as mixtures thereof.

Particularly preferred surfactants are those sold by DuPont under the trademark Zonyl, and, in particular, Zonyl FSP, Zonyl FS62 and Zonyl FSO. Zonyl FSP is described as a perfluorinated anionic functional compound comprising about a 50:50 weight mixture blend of a linear C₄ to C₁₄ perfluoro alkyl ethyl phosphonate acid and a perfluoro alkyl ethyl phosphonic acid surfactant.

Zonyl FS62 and Zonyl 1033D are described as an admixture of perfluosurfonic acids and sulfonates and in particular a mixture of (a) a mixture perflouroalkyl ethylsulfonates, (b) a mixture of ammonium perfluoroalkyl ethyl sulfonates, (c) a minor amount of acid and (d) water

It should be noted that the surfactant is selected depending on the desired foaming conditions. Thus, in a low foam environment, the Zonyl FS-62 would be employed and in a high foam situation the 1033D would be employed.

Other useful, but less preferred, fluoro surfactants are those sold by Innovative Chemical Technologies, Inc. under the trademarks Flexiwet NF, Flexiwet AB28 and Flexiwet AB29.

Flexiwet AB29 is described as a perfluorinated anionic functional compound comprising about a 50:50 weight mixture blend of a linear C₄ to C₁₄ perfluoro alkyl ethyl phosphonate acid and a perfluoro alkyl ethyl phosphonic acid surfactant.

Additionally, a fluorinated alkyl glucoside surfactant may be used herein, as well. Such surfactants are, also, well known and commercially available.

Other useful flurosurfactants are those sold by Mason Chemical under the trademark of Masurf FS230, which is functionally equivalent to Dupont Zonyl 1033D

Generally, the fluorinated surfactant will comprise from about 0.05% to about 5.0% by weight of the surfactant mixture or blend and, preferably, from about 0.10% to about 4.0% by weight of the surfactant or detergent blend.

As noted the detergent blend hereof is used to prepare a detergent concentrate therefrom. In manufacturing the concentrate, the surfactant or detergent blend is present in an amount ranging from about 0.1% to about 5.0%, by weight, based upon the total weight of the concentrate.

In a high pH environment the concentrate, preferably, comprises an aqueous solution of an alkaline base or caustic material, a chlorinated bleach or hydrogen peroxide, the detergent blend and water.

The caustic or base is, preferably, an alkali metal hydroxide, such as, sodium hydroxide, potassium hydroxide, and the like as well as mixtures thereof. Other compounds useful as a base or alkaline material, include, for example, alkali metal carbonates, alkali metal bicarbonates and the like. Preferably, though, the caustic or base material is sodium hydroxide because of its superior properties as a soap. Sodium hydroxide is typically employed as a 50% aqueous solution thereof. Generally, the caustic material, as the 50% aqueous solution, comprises from about 0.1% up to about 50% by weight of the total weight of the concentrate.

Herein, and preferably, from about 0.1% to about 50% of the 50% aqueous caustic solution is used in the final formulation or use solution.

The chlorinated bleach is, preferably, sodium hypochlorite. It is usually used in an amount ranging from about 0.01% by weight up to about 15.0% by weight, based on the final weight of the concentrate.

The balance of the concentrate is water.

The concentrate is prepared by admixing the components together at ambient conditions. The detergent mixture should be premixed together before adding to the remainder of the concentrate. The concentrate is a homogeneous solution and is storage stable.

In preparing a use solution or final formulation from the concentrate, the concentrate is admixed with water at ambient conditions with stirring. As noted above, the use solution will generally contain or be about a 0.05% to about a 50%, by weight, of the 50% aqueous caustic solution, based on the caustic in the concentrate and from about 0.01% to about 15%, by weight, of the chlorinated product or chlorine source.

In other words, the concentrate can be diluted with water to achieve a presence therein of about a 0.01% to about a 10%, by weight, amount of the 50% caustic solution and from about 0.01% to about 15%, by weight of the chlorine source.

The use solution can be deployed by pumping it through the fluid delivery lines, such as a draft line, milk line, etc. In addition, present composition can be used not only for cleaning fluid delivery lines but all food contact surfaces, whether it be liquid or solid. Thus, the present invention, while showing efficacy in cleaning and sanitizing food and beverage production equipment, delivery lines, etc., is equally applicable for cleaning general hard surfaces such as consumer bathroom, kitchen, floor and general surfaces due to its low surface tension.

Generally, such food and beverage delivery lines will be at a temperature from about 50° F. to above about 200° F. The present composition is effective over this range.

Usually, the composition is pumped through the lines for about 2 to about 30 minutes. Thereafter, the line is rinsed at ambient temperatures with water.

As noted, the present detergent blend, when used in a food or beverage production environment, is water soluble and is useful in both acid, base or oxidizing solution situations. The fluorinated surfactant lowers the surface tension to a degree that there is less use solution consumption and faster cleaning cycle times.

For a more complete understanding of the present invention, references are made to the following non-limiting illustrative examples. In the examples, all parts are by weight absent indications to the contrary.

### EXAMPLE I

A surfactant blend stable in strong oxidizing solutions such as sodium hypochlorite or hydrogen peroxide in accordance herewith is prepared by the following procedure:

Into a suitable vessel equipped with stirring means is added the following, at room temperature:

| Ingredient | Amount (pbw) |
|---|---|
| Amine Oxide⁽¹⁾ | 99.5 |
| Fluorinated surfactant⁽²⁾ | .5 |
| | 100.0 |

⁽¹⁾Mackamine C-8
⁽²⁾Zonyl 1033D (35% active)

### EXAMPLE II

Following the procedure of Example II, a chlorine stable detergent blend is prepared from the following:

| Ingredient | Amount (pbw) |
|---|---|
| Amine Oxide⁽¹⁾ | 99.5 |
| Fluorinated surfactant⁽²⁾ | .5 |
| | 100.0 |

⁽¹⁾Mackamine C-8
⁽²⁾Masurf FS230

### EXAMPLE III

This example illustrates the preparation of a detergent concentrate in accordance with the present invention.

Into a suitable vessel equipped with a stirrer is added with stirring at room temperature:

| Ingredient | Amount, (pbw) |
|---|---|
| Water | 93.6 |
| Sodium Hypochlorite (% active) | 5.0 |
| Caustic (% active) | 0.4 |
| Surfactant Blend of Example 1 | 1.0 |
| | 100.00 |

This concentrate is useful in brewery cleaning.

### EXAMPLE IV

Following the procedure of Example III, a detergent concentrate is prepared from the following:

| Ingredient | Amount, (pbw) |
|---|---|
| Water | 93.6 |
| Sodium Hypochlorite (% active) | 5.0 |
| Caustic (% active) | 0.4 |
| Surfactant Blend of Example II | 1.0 |
| | 100.00 |

### EXAMPLE V

The surfactant blends of Example 1 and Example 2 are diluted in bleach and sodium oxide in accordance with the formula:

| | | |
|---|---|---|
| 1 | wt % | surfactant blend |
| 0.5 | wt % | NaOH |
| 98.5 | % | Clorox Regular Bleach |
| 100 | | |

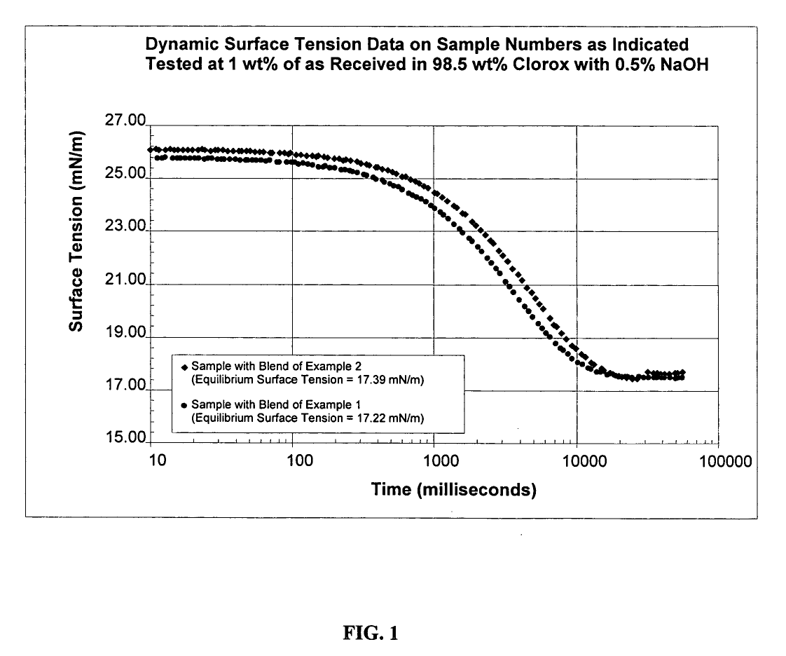

The dynamics of surface tension of these samples are tested using the bubble pressure technique producing the results shown in FIG. 1 which illustrates the surface tension of each sample as studied in 5 milliseconds increments to about 50 seconds (50,000 milliseconds). The tests illustrate the samples achieve equilibrium presented in the following table.

| | Test #1 | Test #2 | Average |
|---|---|---|---|
| Sample | (mN/m) | (mN/m) | (mN/m) |
| Sample with Blend of | 17.39 | 17.42 | 17.41 |
| Example 2 | | | |
| Sample with Blend of | 17.22 | 17.23 | 17.23 |
| Example 1 | | | |

### EXAMPLE VI

The surfactant blends of Example 1 and Example 2 are each mixed with sodium hydroxide and Clorox bleach in the following proportions:

| | | |
|---|---|---|
| 1 | wt % | surfactant blend |
| 0.5 | wt % | NaOH |
| 98.5 | % | Clorox Regular Bleach |
| 100 | | |

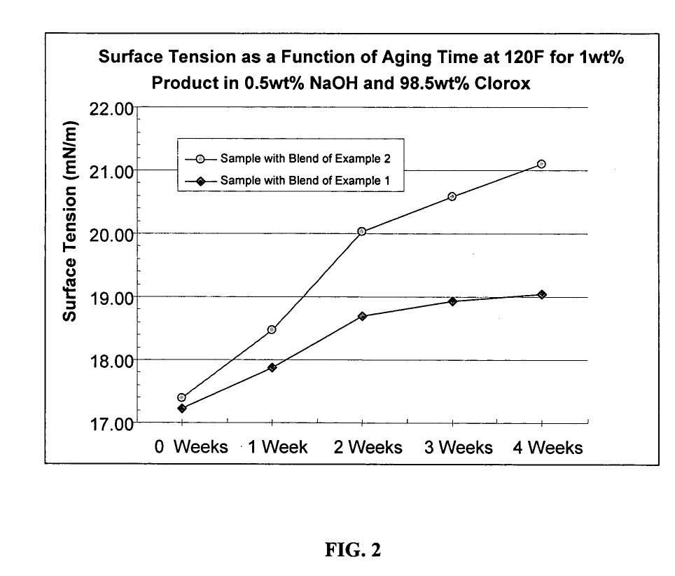

These samples are then tested for equilibrium surface tension by the Wilhelmy plate method at room temperature (72° F.). Following initial testing, the samples are placed in an oven and held at 120° F. for four weeks. They are removed briefly, brought to room temperature and tested again for surface tension. Duplicate tests are performed at each time interval which produces the results shown graphically in FIG. 2 and presented in the following tables.

Example 1 at 1 wt %

| | Test #1 | Test #2 | Average |
|---|---|---|---|
| Age | (mN/m) | (mN/m) | (mN/m) |
| Initial Measurement | 17.21 | 17.23 | 17.22 |
| 1 Week at 120° F. | 17.87 | 17.86 | 17.87 |
| 2 Weeks at 120° F. | 18.69 | 18.70 | 18.70 |
| 3 Weeks at 120° F. | 18.93 | 18.93 | 18.93 |
| 4 Weeks at 120° F. | 19.05 | 19.02 | 19.04 |

Example 2 at 1 wt %

| | Test #1 | Test #2 | Average |
|---|---|---|---|
| Age | (mN/m) | (mN/m) | (mN/m) |
| Initial Measurement | 17.38 | 17.39 | 17.39 |
| 1 Week at 120° F. | 18.48 | 18.46 | 18.47 |
| 2 Weeks at 120° F. | 20.03 | 20.02 | 20.03 |
| 3 Weeks at 120° F. | 20.59 | 20.58 | 20.59 |
| 4 Weeks at 120° F. | 21.10 | 21.10 | 21.10 |

Advantageously, the surfactant blends of the present invention provide for lower surface tension. Lower dynamic surface tension means quicker and more thorough spreading, improved penetration of surfaces and substrates and less streaking. Ultimately this results in cleaning solutions which clean substrates faster and more thoroughly. Ideal applications for this invention include all strong oxidizing cleaners such as chlorine or peroxide-based cleaners where the major functionality is disinfections, killing mold, etc. These products may be used in brewery cleansers, bleach products, mildew & mold tile cleaners, deck cleaners, toilet bowl and general hard surface chlorine-based cleaners. In addition it may be possible to use less cleaning product to acquire the same level of cleaning & disinfection results. It may also be possible in certain product formulations to incorporate less oxidizing agent such as sodium hypchlorite and still acquire the same level of cleaning & disinfection results as well. In addition to providing the right physical properties to acquire faster cleaning and improved disinfection this invention also does not contain any traces of EO, PO or 1,4-dioxanes.

Having described my invention in such terms as to enable those skilled in the art to understand and practice it, and, having identified the presently preferred embodiments thereof, I claim:

1. A detergent blend which comprises:
(a) an anionic or amine oxide surfactant, and
(b) a fluorinated surfactant.

2. The detergent blend of claim 1 wherein the fluorinated surfactant is selected from the group consisting of:
F(CF₂CF₂)ₙ(RO)ₓX
and
CF₃—CF₂(CF₂CF₂)ₙ(CH₂)_{y}X
where R is alkyl from 2 to about 4, n is an integer from 1 to about 9, y is an integer from 0 to about 15 and X is either hydrogen or an anionic radical selected from the group consisting of sulfate, sulfonate, phosphate, phosphonate, ammonium, thiosulfate, thiosulfonate and mixtures thereof.

3. The detergent blend of claim 1 wherein the fluorinated surfactant corresponds to the formula:
F(CF₂CF₂)ₙCF₂CF₂O(CF₂CF₂O)ₓH
where n is an integer from about 1 to about 7 and x is an integer from about 0 to about 15.

4. The detergent blend of claim 1 wherein the fluorinated surfactant is a perfluorinated anionic functional compound comprising about a 50:50 weight mixture blend of a linear C₄ to C₁₄ perfluoro alkyl ethyl phosphonic acid and a perluoro alkyl ethyl phosphonic acid.

5. The detergent blend of claim 1 wherein the amine oxide surfactant corresponds to the formula: 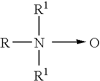
wherein R is lower alkyl having from above 2 to about 18 carbon atoms in the alkyl portion, each R¹ is, independently, where R is a alkyl group having from 6-18 carbon atoms, and each R¹ is, independently, methyl, ethyl, or 2-hydroxethyl.

6. The detergent blend of claim 5 wherein the amine oxide surfactant is octyl-dimethylamine oxide.

7. A detergent concentrate comprising from about 0.05% to about 5.0% by weight of the blend of (a) an anionic or amine oxide surfactant, and (b) a fluorinated surfactant.

8. The concentrate of claim 7 which further comprises:
an aqueous caustic material and water.

9. The concentrate of claim 8 wherein the aqueous caustic material is an aqueous solution of caustic soda.

10. A use solution comprising:
water; and
a concentrate of from about 0.05% to about 5.0% by weight of the blend of (a) an anionic or amine oxide surfactant and (b) a fluorinated surfactant.

11. The use solution of claim 11 wherein:
(a) the use solution contains from about 0.1% to about 50%, by weight, of an aqueous caustic solution.

12. A method of cleaning a food or beverage contact surface which comprises:
contacting the surface with the composition of water and
a concentrate of the blend of: (a) an anionic or amine oxide surfactant and (b) a fluorinated surfactant.

13. The method of claim 12 wherein:
contacting the surface includes pumping the composition through a fluid delivery line at a temperature ranging from about 50° F. to about 200° F.

14. The method of claim 13 which further comprises:
rinsing the line at ambient temperatures after pumping the use solution therethrough.

15. The method of claim 12 wherein the fluorinated surfactant is selected from the group consisting of:
F(CF₂CF₂)ₙ(RO)ₓX
and
CF₃—CF₂(CF₂CF₂)ₙ(CH₂)_{y}X
where R is alkyl from 2 to about 4, n is an integer from 1 to about 9, y is an integer from 0 to about 15 and X is either hydrogen or an anionic radical selected from the group consisting of sulfate, sulfonate, phosphate, phosphonate, ammonium, thiosulfate, thiosulfonate and mixtures thereof.

16. The method of claim 12 wherein the fluorinated surfactant corresponds to the formula:
F(CF₂CF₂)ₙCF₂CF₂O(CF₂CF₂O)ₓH
where n is an integer from about 1 to about 7 and x is an integer from about 0 to about 15.

17. The method of claim 12 wherein the fluorinated surfactant is a perfluorinated anionic functional compound comprising about a 50:50 weight mixture blend of a linear C₄ to C₁₄ perfluoro alkyl ethyl phosphonic acid and a perluoro alkyl ethyl phosphonic acid.

18. The method of claim 12 wherein the amine oxide surfactant corresponds to the formula: 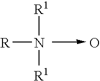
wherein R is lower alkyl having from above 2 to about 18 carbon atoms in the alkyl portion, each R¹ is, independently, where R is a alkyl group having from 6-18 carbon atoms, and each R¹ is, independently, methyl, ethyl, or 2-hydroxethyl.

19. The method of claim 18 wherein the amine oxide surfactant is ooctyl-dimethylamine oxide.
